(19) United States
(12) Patent Application Publication
(10) Pub. No.: US 2025/0015383 A1
(43) Pub. Date: Jan. 9, 2025

(54) THERMAL FABRIC WITH INTEGRATED COOLANT TUBE FOR THEREMALLY INSULATING AND ISOLATING CELLS OF AN ELECTRIC VEHICLE BATTERY PACK AND METHOD OF CONSTRUCTION

(71) Applicant: FEDERAL-MOGUL POWERTRAIN LLC, Northville, MI (US)

(72) Inventor: Scott McFarland, Phoenixville, PA (US)

(21) Appl. No.: 18/218,357

(22) Filed: Jul. 5, 2023

(51) Int. Cl. H01M 10/653; D04B 1/22; D04B 21/20; H01M 10/613; H01M 10/625; H01M 10/656; H01M 50/209

(52) U.S. Cl. CPC H01M 10/653; D04B 1/22; D04B 21/20; H01M 10/613; H01M 10/625; H01M 10/656; H01M 50/209; D10B 2505/12; H01M 2220/20

(57) ABSTRACT

A thermal fabric for a battery pack of an electric vehicle has a knit wall including at least one generally planar portion having a plurality of knit layers overlying one another. A coolant conduit is captured between a pair of the knit layers. The thermal fabric is wrappable about the battery pack and/or configured to be disposed between and about adjacent cells of the battery pack to thermally insulate and isolate the cells and protect against thermal runaway and flame propagation both from the battery pack and between adjacent cells.

### BACKGROUND OF THE INVENTION

### 1. Technical Field

This invention relates generally to electric vehicle battery packs, and more particularly to insulation for electric vehicle battery packs.

### 2. Related Art

While advancements have been made in electric vehicle battery packs, referred to hereafter as batteries, that allow them to deliver more power and require less frequent charges, one of the biggest challenges that remain for battery safety is the ability to design an effective insulation that meets ever increasing safety focused requirements.

In electric cars, discharging the battery during use generates heat, and the more rapidly a battery is discharged, the more heat is generated. Batteries work based on the principle of a voltage differential, and at high temperatures, the electrons inside the battery become excited, which decreases the difference in voltage between terminals of the battery. Batteries are only capable of functioning between certain temperature extremes, and thus, if there is no cooling system to keep the battery in a working temperature range, it will not function as intended. Cooling systems generally need to be able to keep the battery pack in the temperature range of about 20-40 degrees Celsius, as well as keep the temperature difference within the battery to a minimum (generally no more than 5 degrees Celsius differential).

If there is a large internal temperature difference, it can lead to different charge and discharge rates for each cell of the battery pack and deteriorate the battery pack performance. Potential thermal stability issues, such as capacity degradation, thermal runaway, and fire explosion, could occur if the battery overheats or if there is non-uniform temperature distribution in the battery pack. In the face of safety enhancement, innovation is desired in the electric vehicle industry to improve the battery cooling system.

It is known to contain or shield battery packs, including those used in electric vehicle applications, in thermal insulation. A common material used to form such thermal insulation is a fiberglass fabric. Although the fiberglass fabric insulation provides an acceptable level of protection against contamination and environmental temperatures during normal use, the fiberglass fabric insulation does not provide a desired level of protection against flame propagation, such as may be experienced in a thermal runaway condition of one or more cells of the electric vehicle battery pack. As shown in FIGS. 2A-2C, a battery pack 1 and housing 2 thereof are shown having a fiberglass insulator between and about cells 3 of the battery pack 1. The fiberglass insulator can result in a thermal runaway condition originating in any one of the cells 3 of the battery pack 1, such that flame propagates from a single cell 3 (FIG. 6A) to multiple cells 3 (FIGS. 6B and then 6C), in less than 5 minutes at a temperature of 1000° C.

It is desired to provide a single component thermal insulation that is effective in serving multiple functions, including providing resilient cushioning between adjacent cells of a battery pack as they expand and contract, providing thermal insulation between the cells and about the battery pack, and providing resistance to thermal runaway and inhibiting the propagation of flame between cells of a battery pack for 5 minutes or more at a temperature of 1000° C.-1200° C.

### SUMMARY OF THE INVENTION

In according with one aspect of the disclosure, a thermal fabric for a battery pack of an electric vehicle is provided. The thermal fabric is economical in manufacture and in assembly. The thermal fabric isolates individual cells of a battery pack from one another, and maintains the temperature of the individual cells within desire working temperature limits. Further yet, the thermal fabric prevents a thermal runaway condition within an individual cell from spreading to adjacent cells. The thermal fabric includes a wall having at least one generally planar portion including a plurality of knit layers overlying one another, and a coolant conduit is captured between a pair of the plurality of knit layers.

In accordance with another aspect of the invention, the wall is configured to be disposed in sandwiched relation between adjacent cells of the battery pack.

In accordance with another aspect of the invention, the wall can be configured to be disposed about the cells of the battery pack.

In accordance with another aspect of the invention, the wall can be configured to be disposed in sandwiched relation between adjacent cells of the battery pack and about the cells of the battery pack.

In accordance with another aspect of the invention, the wall can be configured to be wrapped about an individual cell of the battery pack to fully enclose all sides of the cell.

In accordance with another aspect of the invention, the coolant conduit can be routed within the wall of the thermal fabric to be routed along all sides of the enclosed cell.

In accordance with another aspect of the invention, the at least one generally planar portion can include a first wall portion and a second wall portion spaced from the first wall portion, with the first and second wall portions being connected to one another by a third wall portion. The first and second wall portions being configured to face one another in generally parallel relation, while the third wall portion extends generally transversely to the first and second wall portions.

In accordance with another aspect of the invention, the coolant conduit extends through the first, second, the third wall portions.

In accordance with another aspect of the invention, the first and second wall portions are connected to the third wall portion by a pair of first hinge regions, wherein the pair of first hinge regions extend generally parallel to one another.

In accordance with another aspect of the invention, the coolant conduit extends in serpentine fashion back-and-forth to define a plurality of linearly straight conduit portions, wherein the plurality of linearly straight conduit portions extend generally parallel to one another.

In accordance with another aspect of the invention, the plurality of linearly straight conduit portions extend generally parallel to said pair of first hinge regions, thereby facilitating folding of the first hinge regions, as desired.

In accordance with another aspect of the invention, the coolant conduit has an inlet configured to channel coolant into the first wall portion and an outlet configured to channel the coolant away from the second wall portion.

In accordance with another aspect of the invention, the third wall portion has opposite free ends, wherein at least one of the first and second wall portions has a cover portion extending beyond at least one of the opposite free ends.

In accordance with another aspect of the invention, each of the first and second wall portions includes the cover portion, wherein the cover portions extend beyond at least one of the opposite free ends of the third wall portion.

In accordance with another aspect of the invention, each of the cover portions folds along a cover hinge region into transverse relation with the first and second wall portions.

In accordance with another aspect of the invention, at least one of the cover portions forms at least a portion of a first side cover portion extending from one of the opposite free ends and at least one of said cover portions forms at least a portion of a second side cover portion extending from the other of the opposite free ends.

In accordance with another aspect of the invention, a pair of the cover portions forms the first side cover portion and a pair of the cover portions forms the second side cover portion.

In accordance with another aspect of the invention, the coolant conduit extends through the first and second side cover portions.

In accordance with another aspect of the invention, the coolant conduit extends through the cover portion.

In accordance with another aspect of the invention, a battery pack of an electric vehicle is provided. The battery pack includes a plurality of battery cells. A thermal fabric is disposed about separate ones of the plurality of battery cells. The thermal fabric has a planar wall including a plurality of knit layers overlying one another, wherein the planar wall abuts sides of the battery cells. A coolant conduit is captured between a pair of the plurality of knit layers to facilitate maintaining the temperature of the cell within a desired working temperature range and to facilitate preventing a thermal runaway condition between cells.

In accordance with another aspect of the invention, the planar wall has a plurality of orthogonal planar portions, with at least some of the orthogonal planar portions being connected to one another by a living hinge, with the coolant conduit extending across the living hinge and continuously through the plurality of orthogonal planar portions.

In accordance with another aspect of the invention, the plurality of orthogonal planar portions form a rectangular box to enclose and insulate separate ones of the plurality of battery cells therein.

In accordance with another aspect of the invention, a method of constructing a thermal fabric for thermally isolating separate cells of a battery pack of an electric vehicle from one another is provided. The method of constructing the thermal fabric includes knitting a wall having at least one generally planar portion including a plurality of knit layers overlying one another. Further, capturing a coolant conduit between a pair of the plurality of knit layers while knitting the wall.

In accordance with another aspect of the invention, the method can further include knitting the wall having a plurality of planar portions, and connecting adjacent planar portions to one another by a living hinge, and capturing the coolant conduit between the pair of knit layers of each of the plurality of planar portions.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric vehicle having a battery pack with a thermal fabric having a coolant tube captured between layers of the thermal fabric in accordance with the disclosure;

FIG. 2 is an enlarged schematic perspective view of the thermal fabric shown disposed about a cell of the battery pack in accordance with one aspect of the disclosure;

FIG. 3 is a schematic, unfolded plan view of the thermal fabric of FIG. 2 shown as initially constructed and prior to being folded about a cell of the battery pack;

FIG. 3A is a schematic cross-sectional view taken generally along the line 3A-3A of FIG. 3;

FIG. 4 is a knit stitch diagram illustrating multiple layers as formed on front and rear beds of a knitting machine of a non-limiting example embodiment of the thermal fabric with the coolant tube captured between layers;

FIGS. 5A-5C illustrate schematic perspective views of a battery pack including the thermal fabric disposed between adjacent cells and about the cells of the battery pack, and showing a single one of the cells experiencing a thermal runaway condition with the thermal fabric containing the thermal runaway to the single cell and preventing the thermal runaway condition from spreading to adjacent cells; and

FIGS. 6A-6C are similar to FIGS. 5A-5C, illustrating a battery pack constructed in accordance with the prior art, without a thermal fabric of the disclosure herein, and showing a single one of the cells experiencing a thermal runaway condition (FIG. 6A) with the thermal runaway condition progressively spreading to adjacent cells (FIG. 6B, and then 6C).

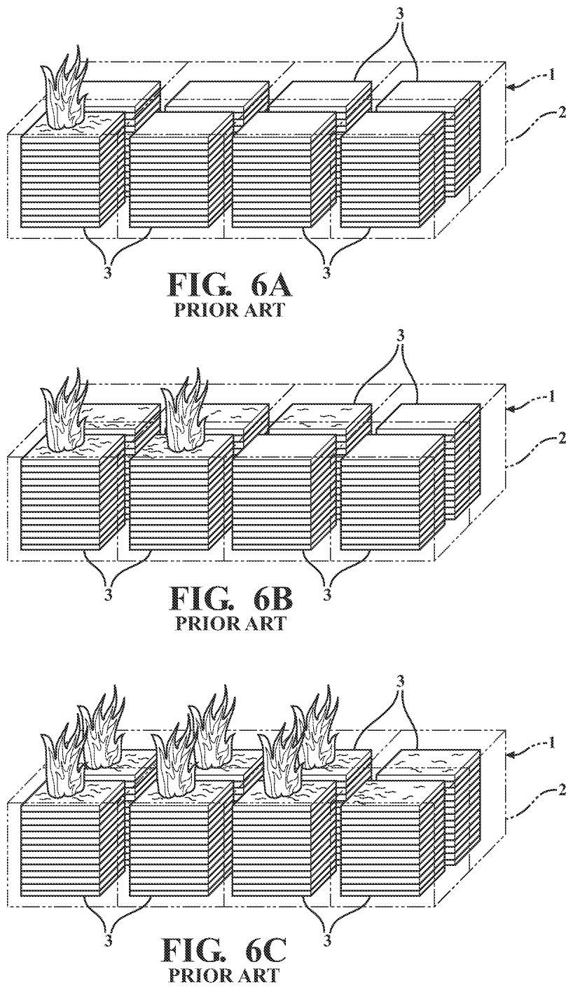

### DETAILED DESCRIPTION OF PREFERRED EMBODIMENTS

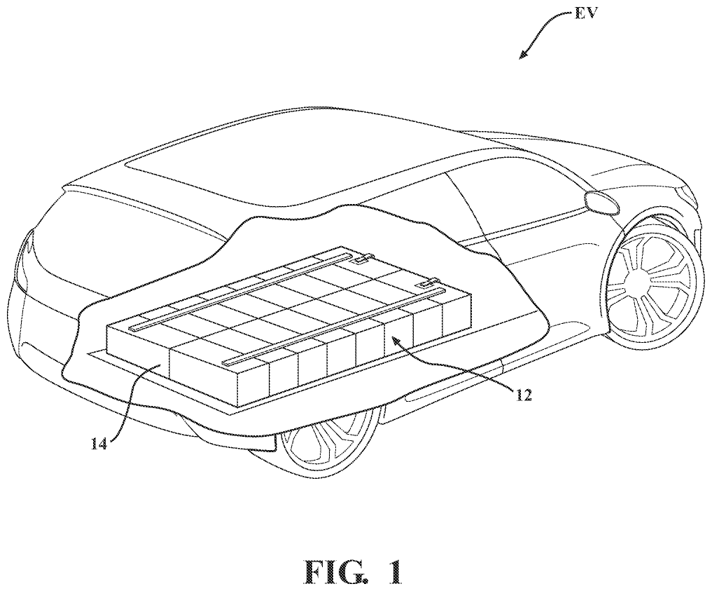

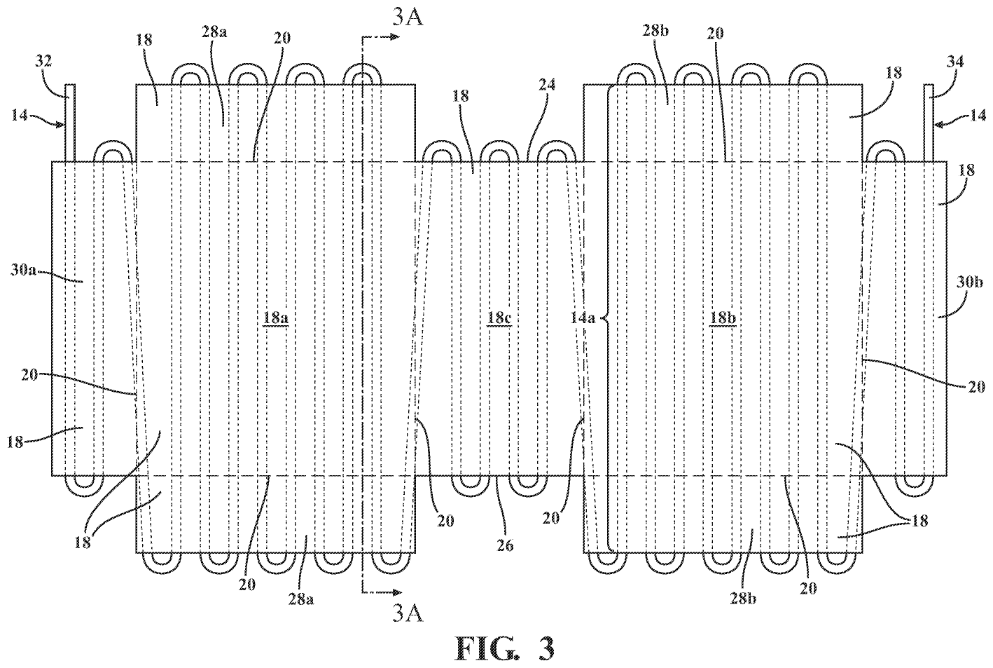

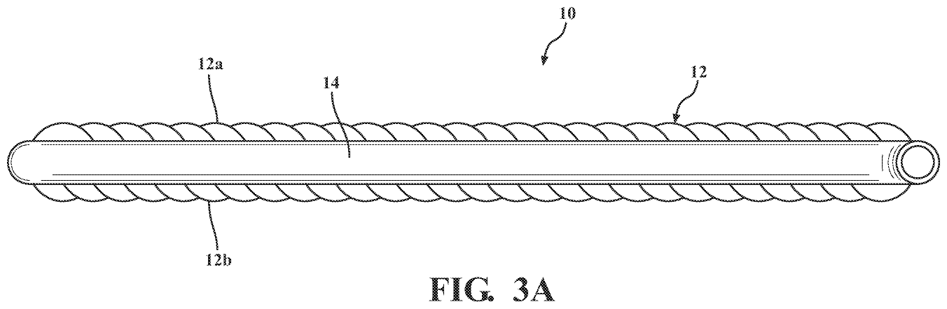

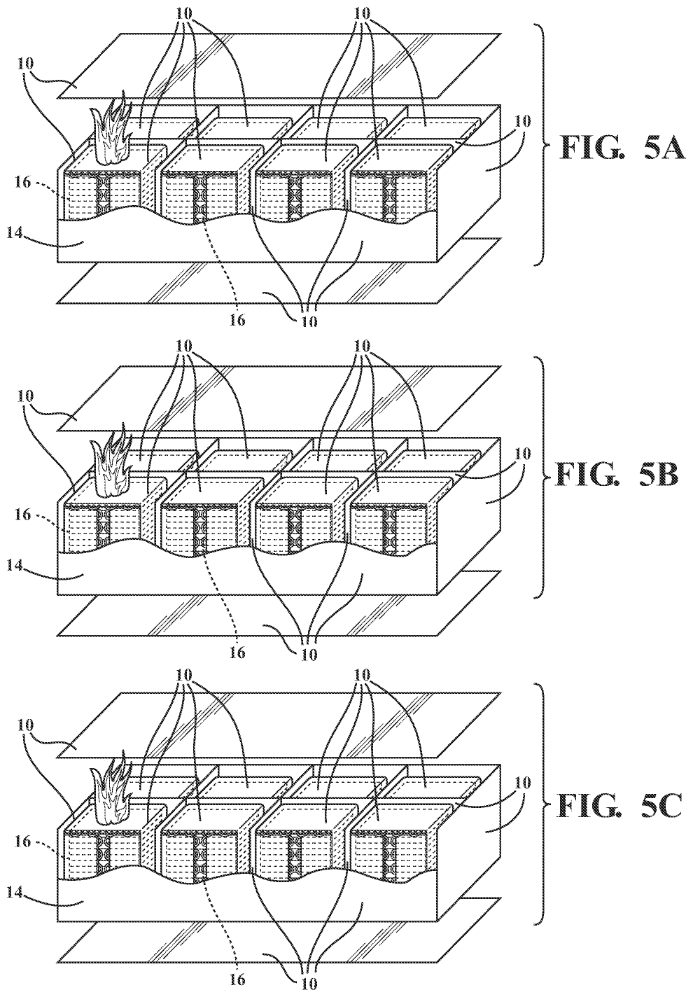

Referring in more detail to the drawings, FIG. 1 illustrates a battery pack and battery cell multilayered thermal fabric, referred to hereafter as thermal fabric 10. The thermal fabric 10, as constructed in accordance with one aspect of the invention, has a multilayered knit wall 12 including a coolant tube, also referred to as coolant conduit 14, captured between opposite sides of the knit wall 12, in sandwiched relation between a pair of knit layers 12a, 12b (FIG. 3A) of the wall 12. The thermal fabric 10 is highly flexible and configured to be disposed about cells 16 of an electric vehicle EV battery pack B (FIGS. 1 and 5A-5C) to maintain the battery pack B in an optimal working temperature range of about 20-40 degrees Celsius, by way of example and without limitation, as well as keep the temperature difference within the battery pack B to a minimum (generally no more than 5 degrees Celsius differential). The flexible wall 12 is able to readily conform to the contours of the cells 16, and as shown, can remain planar along planar surfaces of the cells 16, while being able to be folded about corners of the cells 16, as desired, and as discussed further below. It is to be understood that the wall 12 of a single piece of thermal fabric 10 can be sized to extend about the entire outer periphery of a single cell 16, thereby encapsulating the cell 16, or, if desired, the thermal fabric 10 can be sized to extend along and about multiple cells 16. Regardless of whether the thermal fabric is sized to extend about a single cell 16 or multiple cells 16, the thermal fabric 10 protects the cells 16 protected against impact forces, such as may be experienced in a vehicle crash, ingress of contamination, and thermally against thermal runaway, such as from flame and/or hot gas, by way of example and without limitation. The thermal fabric 10 can also be disposed about an outer periphery of the battery pack B, such as along top, bottom and side surfaces, as schematically shown in FIGS. 5A-5C. The thermal fabric 10, due to its multiple layer knit construction and types of knit stitches and filaments used in its construction, further allows the cells 16 to expand (swell) and contract relative to one another during use, such as can occur during temperature variation, without interfering with one another, thereby preventing adjacent cells 16 from imparting an undesirable compressive force on one another, and thus, preventing damage to one another.

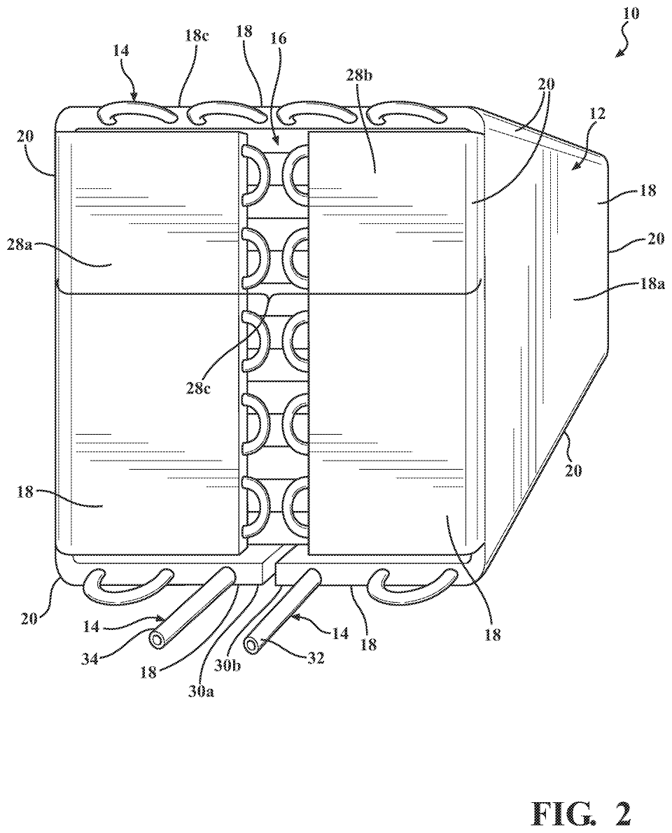

The wall 12 is constructed in a single, continuous knitting process, wherein the coolant conduit 14 is captured between layers of the wall 12 during the knitting process. The wall 12 is knit as a generally flat, planar fabric (FIG. 3), wherein the outer periphery and size of the wall 12 can be customized in the knitting process, as desired. Accordingly, the wall 12 can be shaped and sized to cover one or more cells 16 of the battery B, as desired. In the non-limiting embodiment illustrated in FIGS. 2 and 3, the thermal fabric 10 is sized and shaped to cover a single cell 16 in its entirety, thereby encapsulating the cell 16 about its entire outer surface. As such, maximum protection, thermal, chemical and mechanical, is provided to the cell 16. In the embodiment illustrated, the wall 12, upon being disposed about the cell 16, attains a plurality of generally flat, planar portions 18 extending along and abutting planar surfaces (four sides, top and bottom) of the cell 16, with living hinges 20 allowing the wall 12 to be folded into conformity about the generally rectangular cell 16. It is contemplated herein that the cells 16 could be other than rectangular, with the thermal fabric 10 being able to be constructed and disposed thereabout, as desired. As such, it is to be further understood that the knit fabric of the wall 12, and the coolant conduit 14 captured therein, are flexible, thereby being above to tightly conform about the cell 16, and between adjacent cells 16.

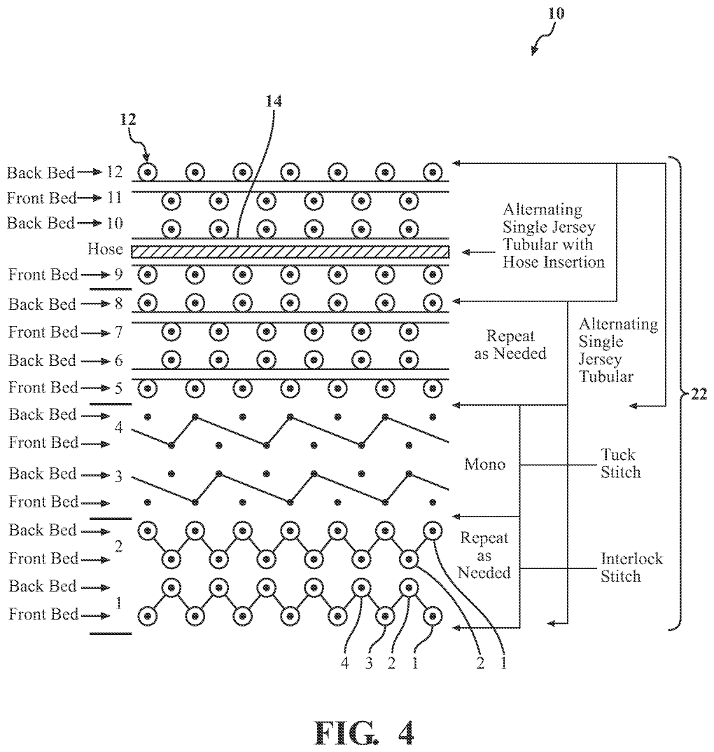

In more detail, the thermal fabric 10 has at least one, and shown as a plurality of generally planar portions 18, with the wall 12 of the thermal fabric 18 having a plurality of knit layers 22 (FIG. 4) overlying one another, with the coolant conduit 14 being captured between a pair of the plurality of knit layers 22. The wall 12 is configured to be disposed in sandwiched relation between adjacent cells 16 (FIGS. 5A-5C) of the battery pack B, and/or to be disposed about the cells 16 of the battery pack B. In the illustrated, non-limiting embodiment, the wall 12 is configured to be disposed in sandwiched relation between adjacent cells 16 of the battery pack B and about the cells 16 of the battery pack B. The wall 12 is shown wrapped about a single, individual cell 16 of the battery pack B to fully enclose all sides (4 orthogonal sides, top and bottom) of the cell 16. The location of the living hinges 20 can be formed as desired to allow the wall 12 to be brought into a generally tight, snug fit about the cell 16.

The plurality of planar portions 18, as best shown in FIG. 3, include a first wall portion 18a and a second wall portion 18b spaced from the first wall portion 18a, with the first wall portion 18a and second wall portion 18b being connected to one another by a third wall portion 18c. The first and second wall portions 18a, 18b are connected to the third wall portion 18c by hinges 20, also referred to as first hinge regions, wherein the pair of first hinge regions 20 extend generally parallel to one another. Upon being disposed and folded along first hinge regions 20 about the cell 16, the first wall portion 18a and second wall portion 18b are configured to face one another in generally parallel relation, while the third wall portion 18c is configured to extend generally transversely to the first and second wall portions 18a, 18b. By way of example and without limitation, the first and second wall portions 18a, 18b extend along long sides of the cell 16, while the third wall portion 18c extends along one of a top or bottom of the cell 16, and shown as forming a top wall portion 18c.

The third wall portion 18c has opposite free ends 24, 26. At least one of the first and second wall portions 18a, 18b, and shown as both of the first and second wall portions 18a, 18b has a respective cover portion 28a, 28b extending beyond at least one of, and shown as both of the opposite free ends 24, 26. Each of the cover portions 28a, 28b folds along a hinge 20, also referred to as a cover hinge region 20, into transverse relation with the first and second wall portions 18a, 18b. Each of the cover portions 28a, 28b forms at least a portion of a first side cover portion 28c (wherein 28c=28a+28b) extending from one of the opposite free ends 24 and at least one of said cover portions 28a, 28b forms at least a portion of a second side cover portion 28c extending from the other of the opposite free ends 26. Accordingly, a pair of the cover portions 28a, 28b forms the first side cover portion 28c and a pair of the cover portions 28a, 28b forms the second side cover portion 28c.

A pair of the planar portions 20, also referred to as bottom wall portions 30a, 30b, extend from each of the first and second wall portion 18a, 18b, with hinges 20 joining the bottom wall portions 30a, 30b to the first and second wall portion 18a, 18b, respectively. Upon being disposed and folded about the cell 16, the bottom wall portions 30a, 30b extend generally parallel to the top wall portion 18c (FIG. 2).

In order to maximize the ability of the thermal fabric to cool the cell 16 and maintain the cell 16 in the optimal temperature range, thereby optimizing running performance and inhibiting thermal runaway, the coolant conduit 14 extends through each of the wall portions, including the first wall portion 18a, second wall portion 18b, third wall portion 18c, top wall portions 28a, 28c, and bottom wall portions 30a, 30b. Accordingly, the coolant conduit 14 can be routed within the wall 12 of the thermal fabric 10 to be routed along all sides of the enclosed cell 16.

The coolant conduit 14 extends in serpentine fashion back-and-forth to define a plurality of linearly straight conduit portions 14a within each of the first wall portion 18a, second wall portion 18b, third wall portion 18c, top wall portions 28a, 28c, and bottom wall portions 30a, 30b. The plurality of linearly straight conduit portions 14a extend generally parallel to one another as constructed. The plurality of linearly straight conduit portions 14a extend generally parallel to the pair of first hinge regions 20, thereby facilitating folding of the first hinge regions 20, as desired. The coolant conduit 14 has an inlet 32 configured to channel coolant into the first wall portion 18a and an outlet 34 configured to channel the coolant away from the second wall portion 18b.

In accordance with a further aspect of the disclosure, a battery pack B of an electric vehicle EV is provided. The battery pack B includes a plurality of battery cells 16 and a thermal fabric 10 disposed about separate ones of the plurality of battery cells 16. The thermal fabric 10 is as discussed above, and thus, includes a planar wall 12 having a plurality of knit layers 22 overlying one another. The planar wall 12 abuts sides of the battery cells 16. A coolant conduit 14 is captured between a pair of the plurality of knit layers 22. At least one planar wall 12 is sandwiched between adjacent cells 16 of the plurality of the cells 16. The planar wall 12, upon being folded about the cell 16, has a plurality of orthogonal planar portions 18a, 18b, 18c, 28a, 28b, 30a, 30b, with at least some of the orthogonal planar portions being connected to one another by a living hinge 20. The coolant conduit 14 extends across the living hinges 20 and continuously through the plurality of orthogonal planar portions 18a, 18b, 18c, 28a, 28b, 30a, 30b. The plurality of orthogonal planar portions 18a, 18b, 18c, 28a, 28b, 30a, 30b form a rectangular box shape to fully enclose and insulate separate ones of the plurality of battery cells 16 therein.

In accordance with another aspect of the invention, a method of constructing a thermal fabric 10 for thermally isolating separate cells 16 of a battery pack B of an electric vehicle EV from one another is provided. The method of constructing the thermal fabric 10 includes knitting a wall 12 having at least one generally planar portion 18 including a plurality of knit layers 12a, 12b overlying one another. Further, capturing a coolant conduit 14 between a pair of the plurality of knit layers 12a, 12b while knitting the wall 12.

The method can further include knitting the wall 12 having a plurality of planar portions 18a, 18b, 18c, 28a, 28b, 30a, 30b, and connecting adjacent planar portions to one another by a living hinge 20, and capturing the coolant conduit 14 between the pair of knit layers 12a, 12b of each of the plurality of planar portions 18.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A thermal fabric for a battery pack of an electric vehicle, comprising:
a wall having at least one generally planar portion including a plurality of knit layers overlying one another; and
a coolant conduit captured between a pair of said plurality of knit layers.

2. The thermal fabric of claim 1, wherein the at least one generally planar portion includes a first wall portion and a second wall portion spaced from the first wall portion, wherein the first and second wall portions are connected to one another by a third wall portion, said first and second wall portions being configured to face one another in generally parallel relation, while said third wall portion extends generally transversely to said first and second wall portions.

3. The thermal fabric of claim 2, wherein said coolant conduit extends through said first, second, and third wall portions.

4. The thermal fabric of claim 3, wherein said first and second wall portions are connected to said third wall portion by a pair of first hinge regions, said pair of first hinge regions extending generally parallel to one another.

5. The thermal fabric of claim 4, wherein said coolant conduit extends in serpentine fashion back-and-forth to define a plurality of linearly straight conduit portions, said plurality of linearly straight conduit portions extending generally parallel to one another.

6. The thermal fabric of claim 5, wherein said plurality of linearly straight conduit portions extend generally parallel to said pair of first hinge regions.

7. The thermal fabric of claim 6, wherein said coolant conduit has an inlet configured to channel coolant into said first wall portion and an outlet configured to channel the coolant away from said second wall portion.

8. The thermal fabric of claim 4, wherein said third wall portion has opposite free ends, at least one of said first and second wall portions having a cover portion extending beyond at least one of said opposite free ends.

9. The thermal fabric of claim 8, wherein each of said first and second wall portions have said cover portion extending beyond at least one of said opposite free ends.

10. The thermal fabric of claim 9, wherein each of said cover portions folds along a cover hinge region into transverse relation with said first and second wall portions.

11. The thermal fabric of claim 10, wherein at least one of said cover portions forms at least a portion of a first side cover portion extending from one of said opposite free ends and at least one of said cover portions forms at least a portion of a second side cover portion extending from the other of said opposite free ends.

12. The thermal fabric of claim 11, wherein a pair of said cover portions forms said first side cover portion and a pair of said cover portions forms said second side cover portion.

13. The thermal fabric of claim 12, wherein said coolant conduit extends through said first and second side cover portions.

14. The thermal fabric of claim 8, wherein said coolant conduit extends through said cover portion.

15. A battery pack of an electric vehicle, comprising:
a plurality of battery cells;
a thermal fabric disposed about separate ones of said plurality of battery cells, said thermal fabric comprising:
a planar wall having a plurality of knit layers overlying one another, said planar wall abutting sides of said battery cells; and
a coolant conduit captured between a pair of said plurality of knit layers.

16. The battery pack of claim 15, wherein said planar wall is sandwiched between adjacent cells of the plurality of the cells.

17. The battery pack of claim 15, wherein said planar wall has a plurality of orthogonal planar portions, at least some of said orthogonal planar portions being connected to one another by a living hinge, said coolant conduit extending across said living hinge and continuously through said plurality of orthogonal planar portions.

18. The battery pack of claim 17, wherein said plurality of orthogonal planar portions form a rectangular box to enclose and insulate separate ones of said plurality of battery cells therein.

19. A method of constructing a thermal fabric for thermally isolating separate cells of a battery pack of an electric vehicle from one another, the method of constructing the thermal fabric, comprising:
knitting a wall having at least one generally planar portion including a plurality of knit layers overlying one another; and
capturing a coolant conduit between a pair of the plurality of knit layers while knitting the wall.

20. The method of claim 19, further including knitting the wall having a plurality of planar portions, and connecting adjacent planar portions to one another by a living hinge, and capturing the coolant conduit between the pair of knit layers of each of the plurality of planar portions.
